(19) United States
(12) Patent Application Publication
(10) Pub. No.: US 2008/0285177 A1
(43) Pub. Date: Nov. 20, 2008

(54) MAGNETIC RECORDING MEDIUM, METHOD FOR MANUFACTURING THE SAME, AND MAGNETIC RECORDING APPARATUS

(75) Inventors: Ryosaku Inamura, Kawasaki (JP); Isatake Kaitsu, Kawasaki (JP); Takuya Uzumaki, Kawasaki (JP); Iwao OKamoto, Higashine (JP); Akira Kikuchi, Higashine-shi (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/105,965

(22) Filed: Apr. 18, 2008

(30) Foreign Application Priority Data
May 15, 2007 (JP) 2007-129627

(51) Int. Cl. G11B 5/33

(52) U.S. Cl. 360/315

(57) ABSTRACT

According to an aspect of an embodiment, a magnetic recording medium includes a substrate, and a first granular layer formed over the substrate, the first granular layer having a plurality of first magnetic particles and Si oxide separating the plurality of first magnetic particles. The magnetic recording medium further includes a second granular layer formed over the first granular layer, the second granular layer having a plurality of second magnetic particles and Ti oxide separating the plurality of second magnetic particles.

### BACKGROUND

This art relates to a magnetic recording medium for use in hard disk drives and other devices, a method for manufacturing the magnetic recording medium, and a magnetic recording apparatus including the magnetic recording medium.

Examples of arts related to the magnetic recording medium, the method for manufacturing the medium and the magnetic recording apparatus are discussed in Japanese Laid-open Patent Publication Nos. 2001-155321, and 2005-353256.

### SUMMARY

According to an aspect of an embodiment, a magnetic recording medium includes a substrate; a first granular layer formed over the substrate, the first granular layer having a plurality of first magnetic particles and Si oxide separating the plurality of first magnetic particles; and a second granular layer formed over the first granular layer, the second granular layer having a plurality of second magnetic particles and Ti oxide separating the plurality of second magnetic particles.

### BRIEF DESCRIPTION OF THE DRAWINGS

FIG. 1 is a cross-sectional view of a perpendicular magnetic recording medium according to an embodiment;

FIG. 2 is a schematic view illustrating how to use a perpendicular magnetic recording medium according to an embodiment;

FIG. 3 is a schematic view of an internal structure of a hard disk drive (HDD);

FIG. 4 is a graph of the coercive force;

FIG. 5 is a graph of the slope of normalized magnetization curve near the coercive force;

FIG. 6 is a graph of the S/N ratio;

FIG. 7 is a graph of the low-frequency reproduction output;

FIG. 8 is a graph of the write core width; and

FIG. 9 is a graph of the writability.

### DESCRIPTION OF THE PREFERRED EMBODIMENTS

As the storage capacity of magnetic recording apparatuses increases, the areal recording density of a magnetic recording medium built into the magnetic recording apparatuses increases accordingly. The recording methods of magnetic recording apparatuses are divided broadly into a longitudinal recording method and a perpendicular magnetic recording method. The recording density in the longitudinal recording method is believed to be close to its limit because of the influence of the increasing of recording magnetic field and the disappearance of recording bits due to thermal fluctuations. By contrast, the perpendicular magnetic recording method is being put to practical use, because the recording bits are theoretically stable at high recording density. As in longitudinal recording media, low noise and high stability against thermal fluctuations are also required for perpendicular magnetic recording media.

A recently proposed perpendicular magnetic recording medium includes a so-called granular layer as part of recording layers for the purpose of noise reduction. In the granular layer, magnetic particles are separated from each other by a nonmagnetic insulator, such as an oxide or a nitride. Another proposed perpendicular magnetic recording medium further includes, to achieve both resistance to thermal fluctuations and writability, a layer that is magnetically coupled with a granular layer and that has an anisotropic magnetic field Hk smaller than that of the granular layer and a slope α of a normalized magnetization curve near the coercive force larger than that of the granular layer. The term “normalized magnetization curve”, as used herein, refers to a magnetization curve normalized to saturation magnetization.

Recently, there has been an additional need for higher S/N ratios. However, it is difficult to achieve satisfactorily high S/N ratios by existing techniques.

Accordingly, it is an object of the present invention to provide a magnetic recording medium that has a high coercive force and low noise, a method for manufacturing the magnetic recording medium, and a magnetic recording apparatus including the magnetic recording medium.

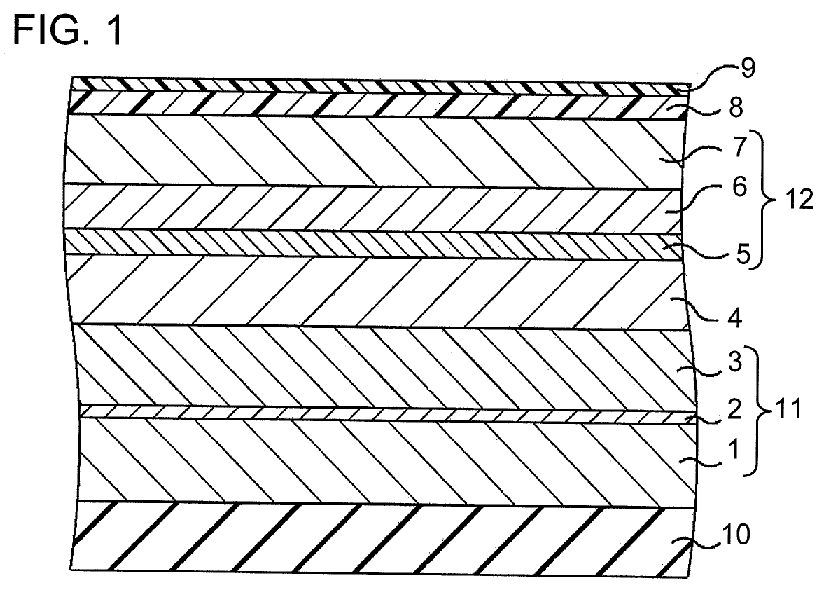

Embodiments will be described in detail below with reference to the drawings. FIG. 1 is a cross-sectional view of a perpendicular magnetic recording medium according to an embodiment.

As illustrated in FIG. 1, a first soft magnetic layer 1, a nonmagnetic separating layer 2, and a second soft magnetic layer 3 are disposed on a discoidal nonmagnetic substrate 10 in this order. The first soft magnetic layer 1, the nonmagnetic separating layer 2, and the second soft magnetic layer 3 constitute a soft under layer 11.

Examples of the nonmagnetic substrate 10 include plastic substrates, crystallized glass substrates, tempered glass substrates, Si substrates, and aluminum alloy substrates.

The first soft magnetic layer 1 and the second soft magnetic layer 3 may have an amorphous or microcrystalline structure containing Fe, Co, and/or Ni. The structure may further contain W, Hf, C, Cr, B, Cu, Ti, V, Nb, Zr, Pt, Pd, and/or Ta. Examples of the first soft magnetic layer 1 and the second soft magnetic layer 3 include an FeCoNbZr layer, a CoZrNb layer, a CoNbTa layer, an FeCoZrNb layer, an FeCoZrTa layer, an FeCoB layer, an FeCoCrB layer, a NiFeSiB layer, an FeAlSi layer, an FeTaC layer, an FeHfC layer, and a NiFe layer, each having an amorphous or microcrystalline structure. In particular, in view of the concentration of recording magnetic fields, the first soft magnetic layer 1 and the second soft magnetic layer 3 are preferably a soft magnetic material layer having a saturation magnetization Bs of at least 1.0 T. The first soft magnetic layer 1 and the second soft magnetic layer 3 may be formed by plating, DC sputtering, RF sputtering, pulse DC sputtering, vapor deposition, or chemical vapor deposition (CVD). In DC sputtering, a chamber may have an Ar atmosphere at a pressure of about 0.5 Pa, and an electric power of about 1 kW may be applied. The thicknesses of the first soft magnetic layer 1 and the second soft magnetic layer 3 may be in the range of 10 to 100 nm, preferably in the range of 30 to 60 nm. The first soft magnetic layer 1 and the second soft magnetic layer 3 having a thickness below these lower limits may have poor read-write characteristics. Furthermore, the thicknesses of the first soft magnetic layer 1 and the second soft magnetic layer 3 above these upper limits may result in an increase in the scale of mass production facilities or a large increase in cost.

The nonmagnetic separating layer 2 may be a nonmagnetic metal layer formed of Ru or a Ru alloy. The nonmagnetic separating layer 2 may also be formed by plating, DC sputtering, RF sputtering, pulse DC sputtering, vapor deposition, or CVD. In DC sputtering, a chamber may have an Ar atmosphere at a pressure of about 0.5 Pa, and an electric power of about 150 W may be applied. The thickness of the nonmagnetic separating layer 2 is designed (for example, in the range of about 0.5 to 1 nm) so that the first soft magnetic layer 1 and the second soft magnetic layer 3 form antiparallel magnetic coupling. More specifically, the magnetization directions of the first soft magnetic layer 1 and the second soft magnetic layer 3 are opposite to each other, and antiferromagnetic coupling is formed between the first soft magnetic layer 1 and the second soft magnetic layer 3. The nonmagnetic separating layer 2 may be formed of a material, such as Re, Cr, Rh, Ir, Cu, or V, as described in “S. S. P. Parkin, Phy. Rev. Lett. 67, 3598 (1991)”.

A nonmagnetic under layer (intermediate layer) 4 is formed on the soft under layer 11. The nonmagnetic under layer 4 magnetically separates the soft under layer 11 from a perpendicular magnetic recording layer 12 described below. The nonmagnetic under layer 4 may be a Ru layer or a Ru alloy layer. The nonmagnetic under layer 4 may also be formed by plating, DC sputtering, RF sputtering, pulse DC sputtering, vapor deposition, or CVD. In DC sputtering, a chamber may have an Ar atmosphere at a pressure of about 8 Pa, and an electric power of about 1 kW may be applied. The nonmagnetic under layer 4 may have a thickness of about 20 nm. As described in Japanese Laid-open Patent Publication No. 2005-353256, the nonmagnetic under layer 4 may be composed of two or more sublayers. Furthermore, a seed layer (a Ta layer, a NiCr layer, etc.) may be disposed between the soft under layer 11 and the nonmagnetic under layer 4 to improve the crystalline orientation of the nonmagnetic under layer 4 and to control the crystal grain size of the nonmagnetic under layer 4.

A Si oxide granular layer 5, a Ti oxide granular layer 6, and a magnetic layer 7 formed of a continuous film are disposed on the nonmagnetic under layer 4 in this order. The Si oxide granular layer 5, the Ti oxide granular layer 6, and the magnetic layer 7 constitute the perpendicular magnetic recording layer 12.

The Si oxide granular layer (first granular layer) means a layer including a plurality of first magnetic particles whose average diameter in the in-plane direction is about 2 to 10 nm, and Si oxide separating the plurality of first magnetic particles from each other, the plurality of first magnetic particles being dispersed in the Si oxide as a whole. The Ti oxide granular layer (second granular layer) means a layer including a plurality of second magnetic particles whose average diameter in the in-plane direction is about 2 to 10 nm, and Ti oxide separating the plurality of second magnetic particles from each other, the plurality of second magnetic particles being dispersed in the Ti oxide as a whole.

In the Si oxide granular layer 5, Si oxide may be disposed between CoCrPt particles (magnetic particles) . In other words, CoCrPt particles are separated from each other by Si oxide. Thus, the Si oxide granular layer may also be referred to as a CoCrPt—SiO₂ layer. In the Ti oxide granular layer 6, Ti oxide may be disposed between CoCrPt particles. In other words, CoCrPt particles are separated from each other by Ti oxide. Thus, the Ti oxide granular layer may also be referred to as a CoCrPt—TiO₂ layer. The Si oxide granular layer 5 and the Ti oxide granular layer 6 may also be formed by plating, DC sputtering, RF sputtering, pulse DC sputtering, vapor deposition, or CVD. In the formation of the Si oxide granular layer 5 by DC sputtering, a chamber may have an Ar atmosphere at a pressure of about 5 Pa, and an electric power of about 100 W may be applied. In the formation of the Ti oxide granular layer 6 by DC sputtering, a chamber may have an Ar atmosphere at a pressure of about 5 Pa, and an electric power of about 300 W may be applied. The magnetic particles in the Si oxide granular layer 5 and the Ti oxide granular layer 6 may be CoCrPt-based alloy particles in place of the CoCrPt particles. The Ti oxide granular layer 6 may contain CoCr-based alloy magnetic particles containing Pt, B, Cu, and/or Ta.

The Si oxide granular layer 5 may have a thickness of about 2 nm. The Ti oxide granular layer 6 may have a thickness of about 8 nm. In the present embodiment, the relationship of “t₁Ms₁:t₂Ms₂=0.25:0.75” holds, wherein t₁Ms₁ denotes the product of film thickness t₁ and saturation magnetization Ms₁ of the Si oxide granular layer 5, and t₂Ms₂ denotes the product of film thickness t₂ and saturation magnetization Ms₂ of the Ti oxide granular layer 6. In other words, the proportion (t₁Ms₁/(t₁Ms₁+t₂Ms₂)) of the product of film thickness t₁ and saturation magnetization Ms₁ of the Si oxide granular layer 5 is 0.25. In the present embodiment, the Si oxide granular layer 5 and the Ti oxide granular layer 6 constitute a composite granular layer.

The magnetic layer 7 formed of a continuous film may be a CoCrPtB layer. Crystal grains in the magnetic layer 7 are in close contact with each other. The magnetic layer 7 may also be formed by plating, DC sputtering, RF sputtering, pulse DC sputtering, vapor deposition, or CVD. In DC sputtering, a chamber may have an Ar atmosphere at a pressure of about 0.5 Pa, and an electric power of about 400 W may be applied. The magnetic layer 7 may have a thickness of about 10 nm. The continuous film may be a polycrystalline film or an amorphous film.

A carbon protective layer 8 is disposed on the magnetic layer 7. The carbon protective layer 8 may be formed by CVD. The carbon protective layer 8 has a thickness of about 4 nm. A lubricating layer 9 is disposed on the carbon protective layer 8. The lubricating layer 9 may be formed by the application of a lubricant. The lubricating layer 9 has a thickness of about 1 nm.

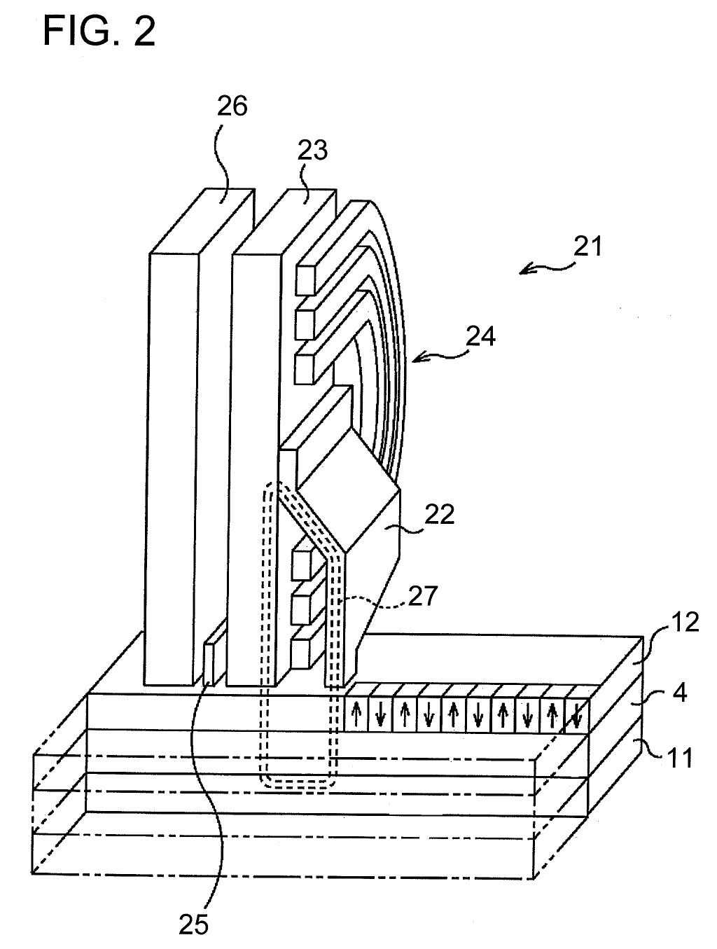

Data are written (recorded) on and read (regenerated) from a perpendicular magnetic recording medium having a structure as described above with a magnetic head 21, as illustrated in FIG. 2. The magnetic head 21 used for a perpendicular magnetic recording medium includes a main magnetic pole 22, an auxiliary magnetic pole 23, and a coil 24 for writing. The magnetic head 21 further includes a magnetoresistive element 25 and a shield 26 for reading. The auxiliary magnetic pole 23 also functions as a shield against the magnetoresistive element 25. In writing of data, an electric current flows through the coil 24, forming a magnetic flux 27 passing through the main magnetic pole 22 and the auxiliary magnetic pole 23. The magnetic flux 27 leaving the main magnetic pole 22 flows into the auxiliary magnetic pole 23 through the recording layer 12 and the soft under layer 11. Thus, the direction of magnetization of each recording bit in the perpendicular magnetic recording layer 12 turns upward or downward according to the direction of the magnetic flux.

Thus, in the present embodiment, the perpendicular magnetic recording layer 12 includes the composite granular layer composed of the Si oxide granular layer 5 and the Ti oxide granular layer 6. Furthermore, among the Si oxide granular layer 5 and the Ti oxide granular layer 6, the Si oxide granular layer 5, in which magnetic particles are more clearly separated than those in the Ti oxide granular layer 6, is disposed closer to the substrate 10, and the Ti oxide granular layer 6, which has read-write characteristics superior to the Si oxide granular layer 5, is disposed closer to the surface (magnetic head side). The whole composite granular layer therefore contains clearly separated magnetic particles, and has a high coercive force and lower noise. In addition, the product t₁Ms₁ smaller than the product t₂Ms₂ results in particularly excellent read-write characteristics. Furthermore, since the magnetic layer 7 is disposed on the composite granular layer, magnetic information can appropriately be written on the composite granular layer. In other words, the magnetic layer 7 facilitates the writing of magnetic information on the composite granular layer.

Preferably, the composite granular layer has an anisotropic magnetic field larger than that of the magnetic layer 7. Preferably, the slope at the coercive force in the normalized magnetization curve of the composite granular layer is smaller than the slope at the coercive force in the normalized magnetization curve of the magnetic layer 7. Under these conditions, the magnetic layer 7 can greatly facilitate writing, which means that it is easy to be recorded on the composite granular layer in saturated magnetization.

No relationship is defined between the product of film thickness and saturation magnetization of the Si oxide granular layer 5 and the product of film thickness and saturation magnetization of the Ti oxide granular layer 6. However, the product t₁Ms₁ smaller than the product t₂Ms₂ results in particularly excellent read-write characteristics. This is because the Ti oxide granular layer 6 more contributes to the improvement of the read-write characteristics. Preferably, the whole composite granular layer has a minimum slope α at the coercive force in a normalized magnetization curve. The slope α is indicative of the degree of separation between magnetic particles by a nonmagnetic insulator. A smaller slope α is indicative of a higher degree of separation, resulting in a higher coercive force and lower noise. The composite granular layer may be composed of three of more sublayers. On the basis of the experimental results described below, the proportion (t₁Ms₁/(t₁Ms₁+t₂Ms₂)) of the product of film thickness t₁ and saturation magnetization t₁Ms₁ of the Si oxide granular layer 5 is preferably in the range of 0.1 to 0.3.

Use of a granular layer having a small coercive force in place of the magnetic layer can cause nonuniformity of density over the recording layer, resulting in insufficient corrosion resistance. Use of a nonmagnetic corrosion-resistant layer in place of the magnetic layer can increase the distance between the recording layer and the magnetic head, resulting in a lower S/N ratio or higher noise. The magnetic layer having a thickness of less than 2 nm may have insufficient corrosion resistance. On the other hand, the magnetic layer having a thickness of more than 12 nm may result in high noise. Hence, the magnetic layer preferably has a thickness in the range of 2 to 12 nm.

The perpendicular magnetic recording medium described above may be manufactured by sequentially forming the layers described above on the nonmagnetic substrate 10. Preferably, projections and foreign substances on the surface are removed, for example, with an abrasive tape, after the formation of the lubricating layer 9.

According to such a manufacturing method, the Si oxide granular layer 5 enhances the separation of the magnetic particles in the Ti oxide granular layer 6. This further improves the read-write characteristics of the Ti oxide granular layer 6.

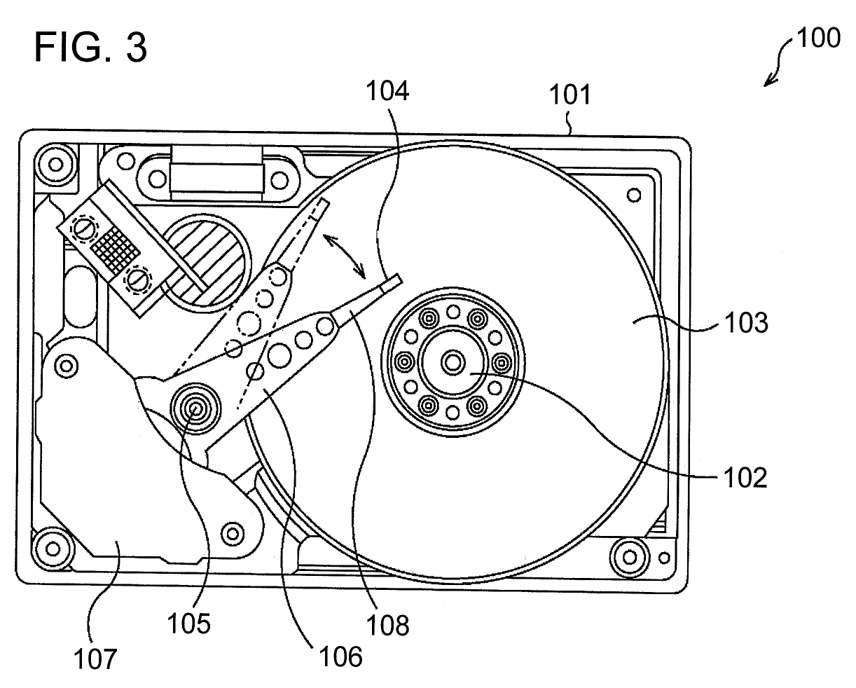

A hard disk drive will be described below as an example of a magnetic recording apparatus that includes a perpendicular magnetic recording medium according to the present embodiment. FIG. 3 illustrates an internal structure of a hard disk drive (HDD).

A hard disk drive 100 includes, in a housing 101, a magnetic disk 103, which is rotated with a rotating shaft 102; a slider 104, which includes a magnetic head for writing information on and reading information from the magnetic disk 103; a suspension 108 for holding the slider 104; a carriage arm 106, which holds the suspension 108 and pivots on an arm shaft 105 over the magnetic disk 103; and an arm actuator 107 for driving the carriage arm 106. The magnetic disk 103 is a perpendicular magnetic recording medium according to the embodiment described above.

The following is an experiment carried out by the present inventors. A several samples of a perpendicular magnetic recording medium were prepared. The samples had different ratios of the product t₁Ms₁ of film thickness t₁ and saturation magnetization Ms₁ of a Si oxide granular layer 5 to the product t₂Ms₂ of film thickness t₂ and saturation magnetization Ms₂ of a Ti oxide granular layer 6. The coercive force, the slope α of a normalized magnetization curve, and the S/N ratio of the samples were determined. The samples had almost the same low-frequency reproduction output, write core width (WCW), and writability. This is because a difference in low-frequency reproduction output, write core width, or writability may affect the S/N ratio. In the measurement of coercive force and slope α, the samples had substantially the same product of film thickness and saturation magnetization of a composite granular layer. In the measurement of S/N ratio, the samples had substantially the same coercive force. The term “write core width”, as used herein, refers to a track width at which information can be written correctly. A smaller write core width indicates that information can be written at a higher track density. The writability was determined as the ratio of a signal read from information written at 124 kilobyte/inch (kBPI) to a signal read from information written at 495 kBPI. The ratio close to −40 dB is indicative of excellent writability.

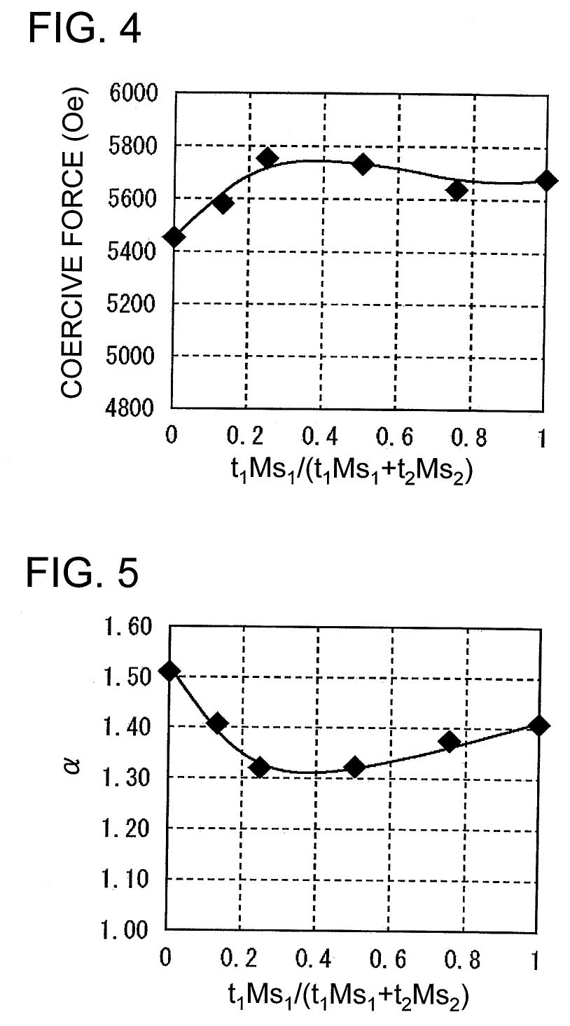

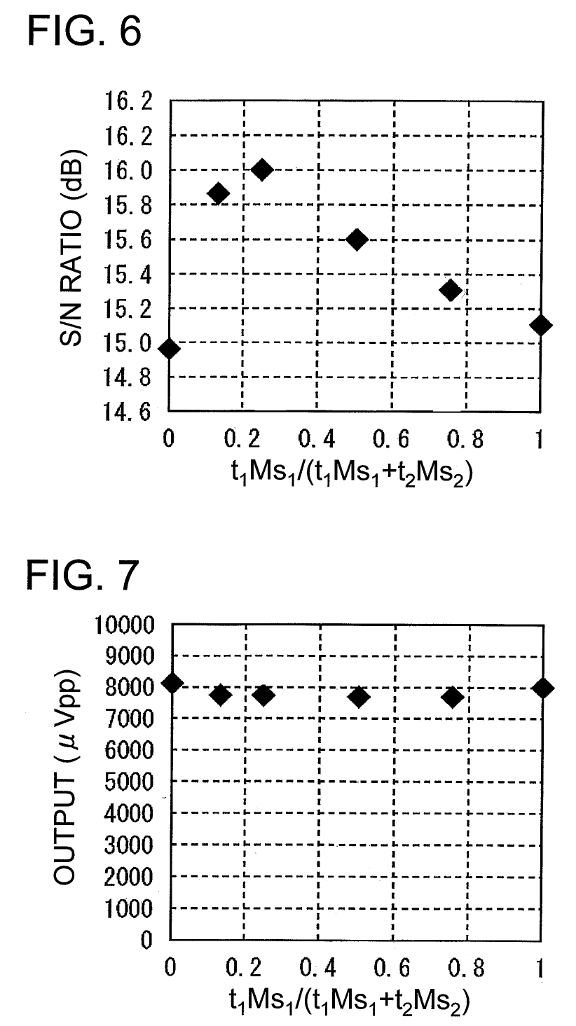

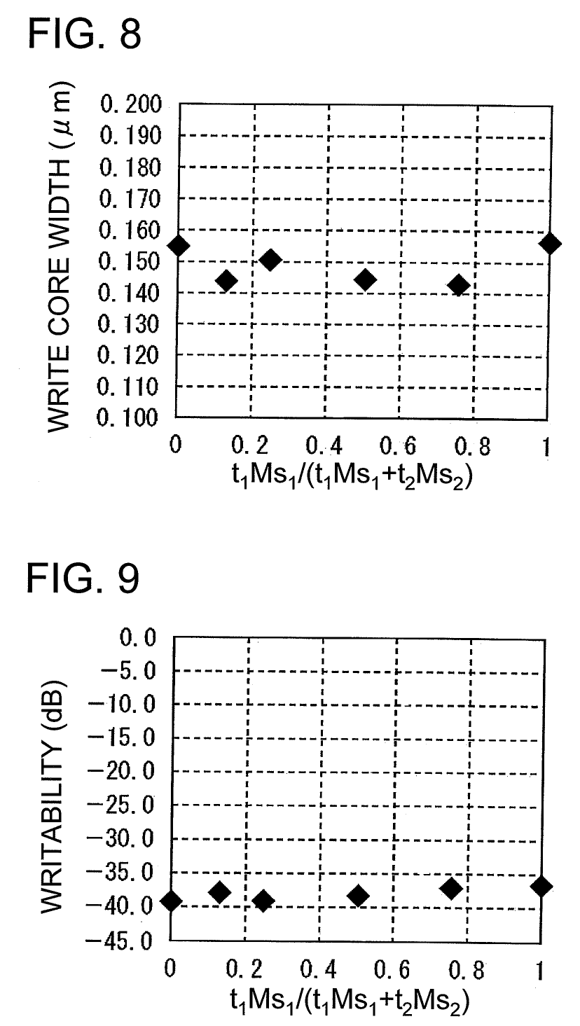

FIG. 4 shows measurements of the coercive force. FIG. 5 shows measurements of the slope α of a normalized magnetization curve. FIG. 6 shows measurements of the S/N ratio. FIG. 7 shows measurements of the low-frequency reproduction output. FIG. 8 shows measurements of the write core width. FIG. 9 shows measurements of the writability. In these figures, the horizontal axis refers to the proportion (t₁Ms₁/(t₁Ms₁+t₂Ms₂)) of the product of film thickness t₁ and saturation magnetization Ms₁ of a Si oxide granular layer 5 in the composite granular layer.

FIGS. 7 to 9 show that the samples had substantially the same low-frequency reproduction output, write core width, and writability, as described above.

As shown in FIG. 4, the coercive force reached the maximum at the proportion (t₁Ms₁/(t₁Ms₁+t₂Ms₂)) of about 0.25. As shown in FIG. 5, the slope α reached the minimum at the proportion (t₁Ms₁/(t₁Ms₁+t₂Ms₂)) of about 0.25. As shown in FIG. 6, the S/N ratio reached the maximum at the proportion (t₁Ms₁/(t₁Ms₁+t₂Ms₂)) of about 0.25. These results clearly show the presence of a certain relationship between the slope α, and the coercive force and the S/N ratio. More specifically, a smaller slope α resulted in a higher coercive force and a higher S/N ratio. Among the samples prepared in this experiment, a sample having the proportion (t₁Ms₁/(t₁Ms₁+t₂Ms₂)) of about 0.25 had the most preferable read-write characteristics. Furthermore, FIGS. 4 to 6 show that samples having the proportion (t₁Ms₁/(t₁Ms₁+t₂Ms₂)) in the range of about 0.1 to 0.3 had particularly preferable read-write characteristics.

Since the samples had almost the same low-frequency reproduction output, write core width, and writability, variations in S/N ratio were independent of these factors. Thus, the aforementioned embodiments can improve the S/N ratio without increasing the write core width.

The most preferable read-write characteristics were achieved at the proportion (t₁Ms₁/(t₁Ms₁+t₂Ms₂)) of about 0.25 in this experiment. However, this optimum proportion is not limited to this value, and depends on the anisotropic magnetic field of the granular layer and the properties of a soft under layer 11, a nonmagnetic under layer 4, and a magnetic layer 7. In view of these effects, particularly preferable read-write characteristics can be achieved at the proportion (t₁Ms₁/(t₁Ms₁+t₂Ms₂)) in the range of about 0.1 to 0.3.

According to the aforementioned embodiments, a combination of a first granular layer, a second granular layer can achieve a high coercive force and low noise.

What is claimed is:

1. A magnetic recording medium comprising:
a substrate;
a first granular layer formed over the substrate, the first granular layer having:
a plurality of first magnetic particles and
Si oxide separating the plurality of first magnetic particles; and
a second granular layer formed over the first granular layer, the second granular layer having:
a plurality of second magnetic particles and
Ti oxide separating the plurality of second magnetic particles.

2. The magnetic recording medium according to claim 1, further comprising:
a magnetic layer formed over the second granular layer.

3. The magnetic recording medium according to claim 1, wherein the product of the thickness and the saturation magnetization of the second granular layer is larger than that of the first granular layer.

4. The magnetic recording medium according to claim 1, wherein the ratio of t₁Ms₁/(t₁Ms₁+t₂Ms₂) is 0.1 to 0.3, where t₁Ms₁ is the product of the thickness t₁ of the first granular layer and the saturation magnetization Ms₁ of the first granular layer and t₂Ms₂ is the product of the thickness t₂ of the second granular layer and the saturation magnetization Ms₂ of the second granular layer.

5. The magnetic recording medium according to claim 2, further comprising:
a composite granular layer including the first granular layer and the second granular layer;
wherein an anisotropic magnetic field of the composite granular layer is greater than that of the magnetic layer, and a slope at the coercive force in the normalized magnetization curve of the composite granular layer is smaller than that of the magnetic layer.

6. The magnetic recording medium according to claim 1, wherein the first magnetic particles contain a Co—Cr—Pt alloy.

7. The magnetic recording medium according to claim 1, wherein the second magnetic particles consist of a Co—Cr alloy containing at least one selected from the group consisting of Pt, B, Cu, and Ta.

8. The magnetic recording medium according to claim 2, further comprising:
a soft under layer between the substrate and the first granular layer;
a recording layer including the first granular layer, the second granular layer and the magnetic layer; and
a nonmagnetic under layer for magnetically separating the soft under layer from the recording layer.

9. The magnetic recording medium according to claim 8, wherein the nonmagnetic under layer contains Ru.

10. The magnetic recording medium according to claim 8, wherein the soft under layer contains at least one selected from the group consisting of Fe, Co, and Ni, and further contains at least one selected from the group consisting of W, Hf, C, Cr, B, Cu, Ti, V, Nb, Zr, Pt, Pd, and Ta.

11. The magnetic recording medium according to claim 2, wherein the thickness of the magnetic layer is 2 to 12 nm.

12. A method for manufacturing a magnetic recording medium comprising:
forming a first granular layer over a substrate, the first granular layer containing a plurality of first magnetic particles and Si oxide separating the plurality of first magnetic particles; and
forming a second granular layer over the first granular layer, the second granular layer containing a plurality of second magnetic particles and Ti oxide separating the plurality of second magnetic particles.

13. The method according to claim 12, further comprising:
forming a magnetic layer over the second granular layer.

14. The method according to claim 12, wherein the product of the thickness and the saturation magnetization of the second granular layer is larger than that of the first granular layer.

15. The method according to claim 12, wherein the ratio of t₁Ms₁/(t₁Ms₁+t₂Ms₂) is 0.1 to 0.3, where t₁Ms₁ is the product of the thickness t₁ of the first granular layer and the saturation magnetization Ms₁ of the first granular layer and t₂Ms₂ is the product of the thickness t₂ of the second granular layer and the saturation magnetization Ms₂ of the second granular layer.

16. The method according to claim 13, wherein a composite granular layer includes the first granular layer and the second granular layer, an anisotropic magnetic field of the composite granular layer is greater than that of the magnetic layer, and a slope at the coercive force in the normalized magnetization curve of the composite granular layer is smaller than that of the magnetic layer.

17. The method according to claim 12, wherein the first magnetic particles contain a Co—Cr—Pt alloy.

18. The method according to claim 12, wherein the second magnetic particles consist of a Co—Cr alloy containing at least one selected from the group consisting of Pt, B, Cu, and Ta.

19. The method according to claim 13, wherein the thickness of the magnetic layer is 2 to 12 nm.

20. A magnetic recording apparatus comprising:
a magnetic recording medium including:
a substrate,
a first granular layer formed over the substrate, the first granular layer having a plurality of first magnetic particles and Si oxide separating the plurality of first magnetic particles, and
a second granular layer formed over the first granular layer, the second granular layer having a plurality of second magnetic particles and Ti oxide separating the plurality of second magnetic particles; and
a magnetic head for writing information on and reading information from the magnetic recording medium.
